(19) United States
(12) Patent Application Publication
(10) Pub. No.: US 2019/0233769 A1
(43) Pub. Date: Aug. 1, 2019

(54) DISINFECTANT COMPOSITION

(71) Applicant: The Procter & Gamble Company, Cincinnati, OH (US)

(72) Inventors: Adam Simon HAYWARD, Durham (GB); Nicola Jane BINNEY, Newcastle upon Tyne (GB)

(21) Appl. No.: 16/253,273

(22) Filed: Jan. 22, 2019

(30) Foreign Application Priority Data
Jan. 31, 2018 (EP) 18154539.3
Dec. 4, 2018 (EP) 18210043.8

(51) Int. Cl. C11D 3/48; C11D 3/30; C11D 3/37; C11D 3/20; C11D 1/66; C11D 17/04

(52) U.S. Cl. CPC C11D 3/48; C11D 3/30; C11D 3/3761; C11D 17/049; C11D 3/3723; C11D 1/66; C11D 3/2068

(57) ABSTRACT

A disinfectant composition imparting a residual biocidal property, the composition including: i) a polymer binder, wherein the polymer binder is an oxazoline homopolymer or an extended or a modified polymer based on an oxazoline homopolymer; ii) a biocidal quaternary ammonium compound; iii) a polyacrylate polymer having a molecular weight from about 100 to about 5,000 g/mol; iv) a glycol ether of formula R1O(R2O)nR3 (I) wherein R1 is a linear or branched C4, C5 or C6 alkyl, a substituted or unsubstituted phenyl, preferably n-butyl R2 is ethyl or isopropyl, preferably isopropyl R3 is hydrogen or methyl, preferably hydrogen n is 1, 2 or 3, preferably 1 or 2; and v) preferably a carrier.

### FIELD OF THE INVENTION

The present invention is in the field of disinfectant compositions. The composition provides improvements in shine.

### BACKGROUND OF THE INVENTION

Compositions as those described in WO 2016/086012 A1 provide long lasting disinfectant benefits. Surfaces treated with such compositions can be left with a poor shine profile, a low drying rate and a sticky/tacky surface that connotes lack of cleanness to the user.

Therefore, a need remains for a disinfectant composition providing long-lasting disinfection which does not reduce surface shine and does not leave visible residues on the surface. Preferably, the composition would be suitable for surfaces which contact food.

### SUMMARY OF THE INVENTION

The present invention relates to a composition comprising a polymer binder, a biocidal quaternary ammonium compound, a polyacrylate, a glycol ether and preferably a carrier. The composition provides good long-lasting antimicrobial properties and at the same time good shine profile of the treated surfaces.

### DETAILED DESCRIPTION OF THE INVENTION

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

As used herein, the terms “microbe” or “microbial” should be interpreted to refer to any of the microscopic organisms studied by microbiologists or found in the use environment of a treated article. Such organisms include, but are not limited to, bacteria and fungi as well as other single-celled organisms such as mould, mildew and algae. Viral particles and other infectious agents are also included in the term microbe.

“Antimicrobial” further should be understood to encompass both microbicidal and microbistatic properties. That is, the term comprehends microbe killing, leading to a reduction in number of microbes, as well as a retarding effect of microbial growth, wherein numbers may remain more or less constant (but nonetheless allowing for slight increase/decrease).

For ease of discussion, this description uses the term antimicrobial to denote a broad-spectrum activity (e.g. against bacteria and fungi). When speaking of efficacy against a particular microorganism or taxonomic rank, the more focused term will be used (e.g. antifungal to denote efficacy against fungal growth in particular). Using the above example, it should be understood that efficacy against fungi does not in any way preclude the possibility that the same antimicrobial composition may demonstrate efficacy against another class of microbes.

Disinfectant Composition

The present invention is directed to a disinfectant composition, preferably the composition is in a liquid form. The composition comprises a quaternary ammonium compound, a polymer binder, a polyacrylate polymer and a glycol ether. The composition may further comprise a carrier (such as water or a low molecular weight alcohol), a surfactant, a colorant, a fragrance, among other components.

The composition is formulated having surface disinfection and residual biocidal properties for at least 24 hours. The composition can be applied to a surface by spraying, rolling, fogging, wiping or other means. The composition acts as a surface disinfectant, killing infectious microbes present on the surface for at least 24 hours.

Once dried, the liquid formulation leaves a residual protective film on the surface. The residual film possesses a biocidal property, enabling it to maintain protection of the surface against microbial contamination for an extended time period after its application.

The disinfectant composition imparts a film with the capacity to quickly kill bacteria and other germs for at least 24 hours after deposit of the film on the treated surface. Quick kill generally refers to a time period of about 30 seconds to about 5 minutes. The film will remain on the surface and is durable to multiple touches and wearing of the surface. After the composition is applied to a surface the surface present a good shine profile.

Polymer Binder

Preferably, the polymer binder is an oxazoline homopolymer. The oxazoline homopolymer has the following structure:

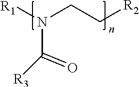

wherein

R1 and R2 are end groups determined by the polymerization techniques used to synthesize oxazoline homopolymer. Ri and R2 are independently selected and include, but are not limited to, hydrogen, alkyl, alkenyl, alkoxy, alkylamino, alkynyl, allyl, amino, anilino, aryl, benzyl, carboxyl, carboxyalkyl, carboxyalkenyl, cyano, glycosyl, halo, hydroxyl, oxazolinium mesylate, oxazolinium tosylate, oxazolinium triflate, silyl oxazolinium, phenolic, polyalkoxy, quaternary ammonium, thiol, or thioether groups. Alternatively, R2 could include a macrocyclic structure formed during synthesis as a consequence of intramolecular attack.

For example, R1 is a methyl group and R2 is oxazolinium tosylate if methyl tosylate is used as the initiator in the cationic initiated polymerization of oxazoline.

R3 is an end group determined by the type of oxazoline used in the preparation of the polymer binder of this invention. R3 includes, but is not limited to, hydrogen, alkyl, alkenyl, alkoxy, aryl, benzyl, hydroxyalkyl, or perfluoroalkyl. For example, R3 is an ethyl group if ethyloxazoline is the monomer used to prepare the polymer binder for the present invention. n is the degree of oxazoline polymerization in the homopolymer. n is in a range of 1 to 1,000,000. Preferably, n is in a range of 500 to 250,000; most preferably, n is in a range of 2500 to 100,000.

Similar to oxazoline homopolymer, extended or modified polymers with some variations based on the oxazoline homopolymer are also suitable for the present invention. The techniques and options for performing chemical or molecular structure variations or modifications to oxazoline should be familiar to those skilled in the art. A class of extended or modified polymers based on oxazoline homopolymer can be represented with the following molecular structure:

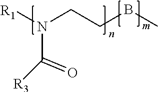

wherein

R1 and R3 have the same definition as those given in the above oxazoline homopolymer.

B is additional monomer repeating unit linked to oxazoline in a coploymer. The types of arrangement of the repeating units between B and oxazoline in the copolymer can include, but are not limited to, block, alternating, periodic, or combinations thereof. There is no limitation as to the types of B that can be used to copolymerize with or modify the oxazoline of the present invention.

n is the degree of polymerization for an oxazoline repeating unit; and m is the degree of polymerization for B repeating unit in the copolymer. Preferably, n is in a range of 500 to 250,000 and m is in a range of 20 to 10,000; and most preferably, n is in a range of 2500 to 100,000 and m is in a range of 50 to 5,000. In addition to linking B to ethyloxazoline through copolymerization, B could also be linked to oxazoline as an end group in a cationic polymerization by using B as a cationic initiator if B itself is already a quaternary ammonium compound.

Not intended to be all inclusive, B can be, for example, ethyleneimine with the following molecular structure:

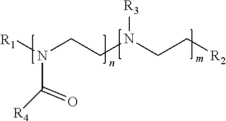

wherein

R1 and R2 end groups have the same definition as those outlined for oxazoline homopolymer.

R3 includes, but is not limited to, hydrogen, alkyl, alkenyl, alkoxy, aryl, benzyl, hydroxyalkyl, or perfluoroalkyl.

R4 includes, but is not limited to, hydrogen, alkyl, alkenyl, alkoxy, aryl, benzyl, hydroxyalkyl, or perfluoroalkyl.

m is in a range of 0 to 500,000; preferably, in a range of 20 to 10,000; and most preferably, in a range of 50 to 5,000.

n is in a range of 1 to 1,000,000; preferably, 500 to 250,000; most preferably, in a range of 2500 to 100,000.

The synthesis of oxazoline and ethyleneimine copolymer can be phased into two steps, for example. In a first step, a cationic ring opening polymerization technique can be used to make polyoxazoline homopolymer. In a second step, the polyoxazoline made in the first step can be hydrolyzed to convert part of polyoxazoline repeating units into polyethyleneimine Alternatively, oxazoline-ethylenimine copolymer can be made with the appropriate respective monomers, an oxazoline and an aziridine. The result would be a cationic polymer having the above structure.

The degree of polymerization for oxazoline repeating unit n in the copolymer is in a range of 1 to 1,000,000 and the degree of polymerization for ethyleneimine repeating unit in the copolymer m is in a range of 0 to 500,000 at the same time. Preferably, n is in a range of 500 to 250,000 and m is in a range of 20 to 10,000, and most preferably n is in a range of 2500 to 100,000 and m is in a range of 50 to 5,000.

Alternatively, the nitrogen in the ethyleneimine repeating unit could be further quarternized to generate the following cationic copolymer:

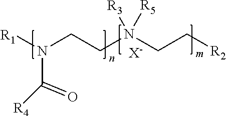

Any quaternization technique that is familiar to those skilled in the art could be used to quaternize the polymer of this example. R1, R2, R3 and R4 have the same meaning as those designated in the above oxazoline-ethyleneimine copolymer. R5 includes, but is not limited to, a hydrogen, methyl, ethyl, propyl, or other types of alkyl group. The corresponding anion X″ is a halogen, sulfonate, sulfate, phosphonate, phosphate, carbonate/bicarbonate, hydroxy, or carboxylate.

The ranges for n and m are also the same as those described in oxazoline-ethyleneimine copolymer.

Another example of B that can be used for the present invention is polydiallyldimethylammonium chloride. Poly ethyloxazo line modified with polydiallyldimethylammonium chloride has the following structure:

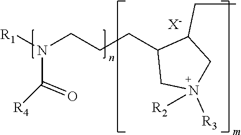

wherein

R1 and R4 have the same meaning as described in previous example for quarternized oxazoline-ethyleneimine copolymer.

R2 and R3, independently, include, but are not limited to, short chain alkyl groups such as Ci to C6. The corresponding anion X″ is a halogen, sulfonate, sulfate, phosphonate, phosphate, carbonate/bicarbonate, hydroxy, or carboxylate.

n and m are defined and numbered the same as in previous examples.

B could be other olefins including, but not limited to, diallyldimethylammonium chloride, styrene, methoxystyrene, and methoxyethene. Ethyloxazoline can also be copolymerized with heterocyclic monomers such as oxirane, thietane, 1,3-dioxepane, oxetan-2-one, and tetrahydrofuran to enhance the performance of the polymer for the present invention. The binder used in this invention could also employ pendant oxazoline groups on a polymer backbone, such as an acrylic or styrene based polymer, or a copolymer containing acrylic or styrene.

Examples of commercially available polyethyloxazo lines include, but are not limited to, Aquazol 500 from Polymer Chemistry Innovations, Inc.

The amount of polymer binder that can be used in the composition can vary somewhat depending upon desired length of residual activity of the composition and the nature of all the other components in the composition. Preferably, the amount of polymer binder in the composition is in a range of 0.1% to 20% by weight of the composition. In liquid formulations for all-purpose and bathroom cleaners, the amount of polymer binder in the liquid formulation is more preferably in a range of 0.1% to 10%, and most preferably in a range of 0.1% to 5%. The polymer binder preferably is water-soluble and can be readily removed from surface if any build up is noticed.

Present in small amounts, it nonetheless can provide a durable bond between biocidal compound and the treated surface to facilitate residual efficacy.

Biocidal Quaternary Ammonium Compound

The biocidal quaternary ammonium compound (QAC) can have the following molecular structure:

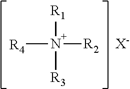

wherein

R1, R-2, P 3, and R4 are independently selected and include, but are not limited to, alkyl, alkoxy, or aryl, either with or without heteroatoms, or saturated or non-saturated. Some or all of the functional groups may be the same.

The corresponding anion X″ includes, but is not limited to, a halogen, sulfonate, sulfate, phosphonate, phosphate, carbonate/bicarbonate, hydroxy, or carboxylate.

QACs include, but are not limited to, n-alkyl dimethyl benzyl ammonium chloride, di-n-octyl dimethyl ammonium chloride, dodecyl dimethyl ammonium chloride, n-alkyl dimethyl benzyl ammonium saccharinate, and 3-(trimethoxysilyl) propyldimethyloctadecyl ammonium chloride.

Combinations of monomeric QACs are preferred to be used for the invention. A specific example of QAC combination is N-alkyl dimethyl benzyl ammonium chloride (40%); N-octyl decyl dimethyl ammonium chloride (30%); di-n-decyl dimethyl ammonium chloride (15%); and di-n-dioctyl dimethyl ammonium chloride (15%). The percentage is the weight percentage of individual

QAC based on the total weight of blended QACs composition.

Polymeric version of the QACs with the following structures can also be used for the invention.

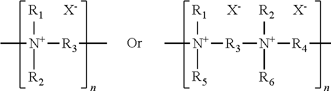

wherein

R1, R2, R5, and R^{A}, independently, include, but are not limited to, hydrogen, methyl, ethyl, propyl or other longer carbon alkyl groups.

R3 and R4 are independently selected and include, but are not limited to, methylene, ethylene, propylene or other longer alkylene linking groups.

n is the degree of polymerization; n is an integer in a range of from 2 to 10,000.

Examples of cationic polymers with the above structure, include but are not limited to, polyamines derived from dimethylamine and epichlorohydrin such as Superfloc C-572 commercially available from Kemira Chemicals.

Still another polymeric QAC suitable for the invention is poly diallyldimethylammonium chloride or polyDADMAC.

Yet another class of QACs useful for the present invention are those chemical compounds with biguanide moiety in the molecule. Examples of this class of cationic antimicrobials include, but are not limited to, PHMB and chlorhexidine. Examples of commercially available quaternary ammonium compounds include, but are not limited to, Bardac 205M and 208M from Lonza, and BTC885 from Stepan Company.

Further biocidal compounds suitable for use in the present liquid formulation span a broad range of antimicrobials, biocides, sanitizers, and disinfectants. A water soluble or dispersible biocidal compound is preferred, although biocides soluble in alcohol may be alternatively employed.

A non-exhaustive list of biocidal compounds suitable for use in the present formulation include triclosan, zinc pyrithione, metal salts and oxides, phenols, botanicals, halogens, peroxides, heterocyclic antimicrobials, aldehydes, and alcohols.

The composition comprises from about 0.05% to about 20%, preferably from 0.05% to 10% by weight of the composition of quaternary ammonium.

Polyacrylate Polymer

The composition of the invention comprises a polyacrylate polymer having a molecular weight from about 100 to about 5,000 g/mol, preferably from 200 to about 3,000, more preferably from 500 to 1,500 g/mol. Preferably the polymer is a homopolymer. Suitable commercially available polyacrylate polymer includes Sokalan PAIS from BASF.

The composition preferably comprises from about 0.0005% to about 5% preferably from about 0.001% to about 1% by weight of the composition of the polyacrylate polymer. More preferably from about 0.05% to about 0.05% by weight of the composition of the polyacrylate polymer. More preferably from about 0.1% to about 1% by weight of the composition of a polyacrylate homopolymer having a molecular weight of from about 1,000 to about 1,500 g/mol.

Glycol Ether Solvent

The composition of the invention comprises a glycol ether of Formula 1:

Formula 1=R1O(R2O)nR3

wherein

R1 is a linear or branched C4, C5 or C6 alkyl, a substituted or unsubstituted phenyl, preferably n-butyl. Benzyl is one of the substituted phenyls for use herein.

R2 is ethyl or isopropyl, preferably isopropyl

R3 is hydrogen or methyl, preferably hydrogen

n is 1, 2 or 3, preferably 1 or 2

Suitable glycol ethers according to Formula 1 include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, ethyleneglycol n-pentyl ether, diethyleneglycol n-pentyl ether, triethyleneglycol n-pentyl ether, propyleneglycol n-pentyl ether, dipropyleneglycol n-pentyl ether, tripropyleneglycol n-pentyl ether, ethyleneglycol n-hexyl ether, diethyleneglycol n-hexyl ether, triethyleneglycol n-hexyl ether, propyleneglycol n-hexyl ether, dipropyleneglycol n-hexyl ether, tripropyleneglycol n-hexyl ether, ethyleneglycol phenyl ether, diethyleneglycol phenyl ether, triethyleneglycol phenyl ether, propyleneglycol phenyl ether, dipropyleneglycol phenyl ether, tripropyleneglycol phenyl ether, ethyleneglycol benzyl ether, diethyleneglycol benzyl ether, triethyleneglycol benzyl ether, propyleneglycol benzyl ether, dipropyleneglycol benzyl ether, tripropyleneglycol benzyl ether, ethyleneglycol isobutyl ether, diethyleneglycol isobutyl ether, triethyleneglycol isobutyl ether, propyleneglycol isobutyl ether, dipropyleneglycol isobutyl ether, tripropyleneglycol isobutyl ether, ethyleneglycol isopentyl ether, diethyleneglycol isopentyl ether, triethyleneglycol isopentyl ether, propyleneglycol isopentyl ether, dipropyleneglycol isopentyl ether, tripropyleneglycol isopentyl ether, ethyleneglycol isohexyl ether, diethyleneglycol isohexyl ether, triethyleneglycol isohexyl ether, propyleneglycol isohexyl ether, dipropyleneglycol isohexyl ether, tripropyleneglycol isohexyl ether, ethyleneglycol n-butyl methyl ether, diethyleneglycol n-butyl methyl ether triethyleneglycol n-butyl methyl ether, propyleneglycol n-butyl methyl ether, dipropyleneglycol n-butyl methyl ether, tripropyleneglycol n-butyl methyl ether, ethyleneglycol n-pentyl methyl ether, diethyleneglycol n-pentyl methyl ether, triethyleneglycol n-pentyl methyl ether, propyleneglycol n-pentyl methyl ether, dipropyleneglycol n-pentyl methyl ether, tripropyleneglycol n-pentyl methyl ether, ethyleneglycol n-hexyl methyl ether, diethyleneglycol n-hexyl methyl ether, triethyleneglycol n-hexyl methyl ether, propyleneglycol n-hexyl methyl ether, dipropyleneglycol n-hexyl methyl ether, tripropyleneglycol n-hexyl methyl ether, ethyleneglycol phenyl methyl ether, diethyleneglycol phenyl methyl ether, triethyleneglycol phenyl methyl ether, propyleneglycol phenyl methyl ether, dipropyleneglycol phenyl methyl ether, tripropyleneglycol phenyl methyl ether, ethyleneglycol benzyl methyl ether, diethyleneglycol benzyl methyl ether, triethyleneglycol benzyl methyl ether, propyleneglycol benzyl methyl ether, dipropyleneglycol benzyl methyl ether, tripropyleneglycol benzyl methyl ether, ethyleneglycol isobutyl methyl ether, diethyleneglycol isobutyl methyl ether, triethyleneglycol isobutyl methyl ether, propyleneglycol isobutyl methyl ether, dipropyleneglycol isobutyl methyl ether, tripropyleneglycol isobutyl methyl ether, ethyleneglycol isopentyl methyl ether, diethyleneglycol isopentyl methyl ether, triethyleneglycol isopentyl methyl ether, propyleneglycol isopentyl methyl ether, dipropyleneglycol isopentyl methyl ether, tripropyleneglycol isopentyl methyl ether, ethyleneglycol isohexyl methyl ether, diethyleneglycol isohexyl methyl ether, triethyleneglycol isohexyl methyl ether, propyleneglycol isohexyl methyl ether, dipropyleneglycol isohexyl methyl ether, tripropyleneglycol isohexyl methyl ether, and mixtures thereof.

Preferred glycol ether solvents according to Formula 1 are ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and mixtures thereof.

The most preferred glycol ether for use herein is dipropyleneglycol n-butyl ether.

The composition of the invention preferably comprises from about 0.1% to about 10%, more preferably from about 0.2 to about 3% by weight of the composition of the glycol ether, more preferably from about 0.2 to about 3% by weight of the composition of dipropyleneglycol n-butyl ether.

Carrier

The carrier or media for the composition of this invention can be any solvent that is volatile and allow easy evaporation at ambient condition. Examples of liquid carriers include, but are not limited to, water and low molecular weight alcohols such as C1 to C8 alkanols. Specific examples include, but are not limited to, ethanol, isopropyl alcohol, butanol, pentanol, and combinations thereof.

Another class of solvents for use in the invention is based on terpenes and their derivatives such as terpene alcohols, terpene esters, terpene ethers, or terpene aldehydes. Examples of solvents, include but are not limited to, pine oil, lemon oil, limonene, pinene, cymene, myrcene, fenchone, borneol, nopol, cineole, ionone and the like.

A preferred carrier in a liquid formulation for a home care cleaning application is water.

If the method of the application of the composition of the present invention is pressurized aerosol, a propellant may be needed in the composition. A variety of propellants or mixtures can be used for the present invention and should be familiar to those skilled in the art. CI to CIO hydrocarbons or halogenated hydrocarbons are typical propellants in aerosol compositions known to the industry. Examples of such propellants include, but are not limited to, pentane, butane, propane, and methane. Other types of propellants that can be used for the present invention also include compressed air, nitrogen, or carbon dioxide. Alternatively, a bag on valve package may be used to aerosol the product without directly add a propellant to the composition.

Either a single solvent or a mixture of the above solvents can be used for the present invention. The types of solvents used for the present invention may depend upon the intended uses of the residual antimicrobial composition. For example, if the composition of the present invent is intended for home care use, cleaning the contaminated surfaces free of all types of dirt or soil may be of primary interest. Liquid carrier or media that assist and enhance the removal of soil may be formulation of the invention.

Surfactant

A surfactant or wetting agent may be employed. The surfactant assists the composition to spread and evenly coat the surface being treated. The surfactant additionally contributes to the formation of a zeotropic mixture between alcohol and water, thus facilitating a rapid and uniform drying of the liquid formulation once being applied onto surface. A surfactant also plays an important role in the residual disinfectant liquid formulation of the present invention for home care use if the soil cleaning performance is the key feature the product is designed to possess.

Surfactants appropriate for the present liquid formulation include, but are not limited to, those that are nonionic, anionic, or amphoteric in nature. Examples of commercially available wetting agents include, but are not limited to, Ecosurf SA-4 or Tergitol TMN-3 from Dow Chemical, and Q2-5211 from Dow Corning.

An amine oxide surfactant is preferred for use herein.

In the category of nonionic surfactants, ethoxylated alcohols with different amounts of ethylene oxides or HLB values can be used. Examples of ethoxylated alcohols include, but are not limited to, Triton X-100 (Dow Chemical, Midland Mich.), Ecosurf EH nonionic surfactant series from Dow Chemical, Tergitol nonionic surfactant series from Dow Chemical, the Surfonic surfactant series from Huntsman Corp., the Neodol surfactant series from Shell, the Ethox surfactant series from Ethox Chemicals and the Tomadol surfactant series from Air Products and Chemicals, Inc.

Another class of nonionic surfactants include alkylpolyglucosides. Examples include the Glucopon Series from BASF and the Ecoteric series from Huntsman

An alternative class of surfactants that is preferred for the liquid formulation are silane-based surfactants. Examples include but, are not limited to, silicone polyethers organofunctional or reactive silane wetting agents, and fluorochemical based wetting agents.

The content of the surfactant in the composition is in a range of 0% to 10%, preferably in a range of 0.01% to 5%.

Depending on the targeted uses, a liquid formulation of the present invention for home care use may need appropriate pH condition. For example, if the liquid product is used in the kitchen area, a high pH product may be desired in order to effectively remove grease soils commonly found in the area. If the product is used in bathroom area, soap scum and hard water deposits may be the primary concern. In such case, a low pH product may be more appropriate for such a purpose.

There is no limitation on the types of pH adjusting agents that can be added into the liquid composition of the present invention. Example of pH adjusting agents that can be used include, but are not limited to, triethanolamine, diethanolamine, monoethanolamine, sodium hydroxide, sodium carbonate, potassium hydroxide, potassium carbonate, calcium carbonate, citric acid, acetic acid, hydrochloric acid, sulfamic acid, sulfuric acid and the like.

Other than components mentioned above, additional functional components may be included in the composition of the present invention. Additional components include, but are not limited to, chelants, compatibilizers, coupling agents, corrosion inhibitors, rheology modifiers, fragrances, colorants, preservatives, UV stabilizers, optical brighteners, and active ingredient indicators.

In an embodiment of the present invention, the composition comprises a polymer binder, a quaternary ammonium compound, a polyacrylate polymer having a molecular weight of from about 800 to about 1,500 g/mol, preferably from 1,000 to 1,500 g/mol, dipropylene glycol n-butyl ether, surfactant, and a carrier comprising water. The composition can be made or mixed by any conventional method known to one of ordinary skill in the art. There are no preferred addition procedures for the formulation of the present invention provided that the formulation is ultimately homogeneous, compatible and stable. For example, if the polymer binder is a solid, it may be preferable to first dissolve or disperse the polymer in a carrier such as water or alcohol to make a stock polymer binder liquid dispersion. The stock polymer binder liquid dispersion may be readily added into the formulation of the present invention during the mixing procedure.

Preferred compositions herein include compositions comprising:

i) from about 0.1% to about 4% by weight of the composition of the polymer binder wherein the polymer binder is preferably prepared with a monomer of ethyloxazoline;

ii) from about 0.05% to about 2% by weight of the composition of the quaternary ammonium compound;

iii) from about 0.001% to about 1% by weight of the composition of a polyacrylate polymer having a molecular weight of from about 800 to about 1,500 g/mol;

iv) from about 0.2% to about 3% by weight of the composition of dipropylene glycol n-butyl ether;

v) from about 0.1% to about 10% of a non ionic surfactant; and

vi) from about 1% to 99% of a carrier selected from the group consisting of water, ethanol, isopropyl alcohol, butanol, pentanol, and combinations thereof.

Application of the Composition

The composition may be applied by a variety of means. If sprayed, the composition advantageously may be supplied in a conventional bottle with a sprayer. The sprayer can be a trigger sprayer. As an option to a trigger sprayer, an aerosol can also be used to deliver the liquid formulation on to surfaces. Additional application means include, but are not limited to, fogging, rolling, brushing, mopping, and using a wipe by a variety of application devices. It is within the scope of the present invention that wipe products can also be made comprising or pre -treated with the disinfectant formulation(s) of the present invention, for example, for off-the-shelf sale or use.

To disinfect a contaminated surface, spray the liquid formulation until the area is completely covered. The wet formulation subsequently may be wiped dry with a dry cloth or paper towel.

The invention also relates to an article treated with a disinfectant formulation in accordance with aspects of the invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

The following examples illustrate improvements in the shine performance of a commercial 24 hr residual self-sanitizing (RSS) composition (Microban 24 hr All Purpose Spray). The composition contains a biocidal quaternary ammonium compound and a polyoxazoline binder (Microban 24 hr All Purpose Spray). It is shown that the addition of low molecular weight polyacrylate (Sokalan PAIS) and dipropylene glycol butyl ether (DPGBE), added directly to the Microban composition, provide improvements in visual surface streaking, residue stickiness and rate of product drying after application.

### Example 1

### Visual Appearance of Surface Residues After Product Application and Drying

Compositions were tested for visual surface streaks after product application and drying. The presence of surface residues, or streaks, is known to be highly undesirable to consumers and can give the impression that the surface has not been effectively cleaned. Briefly, a clean, dry, glossy, black ceramic tile (20 cm×30 cm) was used as a representative hard surface. 0.5 mL of the ready-to-use antimicrobial composition was pipetted diagonally across the tile surface from bottom left to top right to create a continuous liquid deposit on the tile. The liquid deposit was then wiped across the tile using a damp cotton cloth (8 cm×10 cm folded into quarters) using a pattern of x8 wipes horizontally (back and forth), x10 wipes vertically (up and down) and x8 wipes horizontally (back and forth). This wiping regime was conducted in a single continuous motion without lifting the cloth from the tile. The tile was then allowed to dry for 20 minutes. Panelists were then asked to visually grade the appearance of surface streaks on the tile according to the following scale:
0=No streaks
1=Very slight streaks
2=Slight streaks
3=Slight to moderate streaks
4=Moderate streaks
5=Moderate to heavy streaks
6=Heavy streaks

At least 8 panelists evaluated each tile and the experiment was repeated 3 times. Mean streak gradings were calculated, as displayed in Table 1.

TABLE 1
Visual grading of surface streaks after application
and drying of liquid compositions:

| | Mean |
|---|---|
| Liquid composition | streak grade |
| Microban 24 hr All Purpose Cleaner Spray | 5.2 |
| Microban 24 hr All Purpose Cleaner Spray + | 4.6 |
| 0.2% Sokalan PA15 | |
| Microban 24 hr All Purpose Cleaner Spray + | 4.9 |
| 1% DPGBE | |
| Microban 24 hr All Purpose Cleaner Spray + | 3.2 |
| 0.2% Sokalan PA15 + | |
| 1% DPGBE | |

In all the examples, the % are given by weight of the total composition.

### Example 2

### Stickiness of Surface Residues After Product Application and Drying

Compositions were tested for residue stickiness after product application and drying. Sticky residues are problematic to consumers as they can give the impression of poor cleaning and an undesirable sensory feel to the surface. Black, glossy, ceramic tiles were prepared in the same manner as for the visual streak assessments described above. Tiles were then placed onto a Stable Micro Systems Texture Analyser (TA-XT), fitted with a pasta stickiness rig, to measure the stickiness of the dried residues on the tile. The Texture Analyser probe was pushed across the tile surface at an applied force of 0.5 kg and a speed of 0.5 mm/sec, and the resistance force measured, subtracting the force of a non-treated tile (background force). The test was repeated 3 times and the mean resistance force was calculated, as displayed in Table 2. A higher resistance force refers to stickier surface residues.

TABLE 2
Stickiness of surface residues after product application and drying

| Liquid composition | Mean resistance force (g) |
|---|---|
| Microban 24 hr All Purpose Cleaner Spray | 188.1 |
| Microban 24 hr All Purpose Cleaner | 30.7 |
| Spray + 0.2% Sokalan PA15 + | |
| 1% DPGBE | |

### Example 3

### Drying time of Residues After Product Application

Compositions were tested for rate of drying after product application. Faster product drying times are generally regarded more desirable to consumers. Black, glossy, ceramic tiles were prepared in the same manner as for the visual streak assessments described above, but in this instance the weight of the tile was monitored every minute immediately after product application. After 10 minutes of drying, the weight of the tile was plotted against time, and the rate of drying (g/min) was calculated from the slope of the curve. The test was repeated 3 times and the mean drying rate is shown in Table 3.

TABLE 3
Drying rate of compositions after application to a surface

| Liquid composition | Mean drying rate (g/min) |
|---|---|
| Microban 24 hr All Purpose Cleaner Spray | −7.3 |
| Microban 24 hr All Purpose Cleaner | −22.7 |
| Spray + 0.2% Sokalan PA15 + | |
| 1% DPGBE | |

### Disinfection Performance

The following examples illustrate a retention in disinfection performance with the addition of low molecular weight polyacrylate and glycol ether added directly to the Microban 24 hr All Purpose Spray.

### Example 4

### Residual Self-Sanitizing (RSS) Performance (Adapted Protocol)

Compositions were tested for RSS performance using a protocol adapted from the EPA 01-1A test method. Bacteria were inoculated onto a plastic surface and allowed to dry. Compositions were then applied to the surface and also allowed to dry, forming a film. The plastic surface was then subject to 12 alternating wet and dry abrasion cycles over a 24 hour period using a cotton cloth and manual wiping (not a Gardner wear tester as described in EPA01-1A). In between each abrasion cycle the surface was re-inoculated with bacteria, giving a total of 7 inoculations to the surface. On the 7^{th} and final inoculation, bacteria were exposed to the surface for 5 minutes, followed by recovery in an appropriate neutralizing solution. The log reduction was then estimated from serial dilutions.

TABLE 4
Estimated log reduction following an adapted protocol from EPA01-1A

| | RSS EPA01-1A adapted protocol |
|---|---|
| | (estimated log reduction of |
| Liquid composition | Staphylococcus aureus) |
| Microban 24 hr All Purpose Cleaner | 3 |
| Spray | |
| Microban 24 hr All Purpose Cleaner | 3 |
| Spray + 0.2% Sokalan PA15 + | |
| 1% DPGBE | |

### Example 5

### Performance In Surface Disinfection Test EN13697

Compositions were tested for surface disinfection as per the British Standards Institute protocol EN 13697, using 5 minutes contact time and dirty soiled conditions (3.0 g/L Bovine Albumin) Log reductions for the different compositions are shown in Table 5.

TABLE 5
Log reduction in EN 13697 surface disinfection test

| | Log reduction | |
|---|---|---|
| | | Pseudomonas |
| Liquid composition | Staphylococcus aureus | aeruginosa |
| Microban 24 hr All Purpose Cleaner | 6.68 | 5.69 |
| Spray | | |
| Microban 24 hr All Purpose Cleaner | 6.68 | 5.69 |
| Spray + | | |
| 0.2% Sokalan PA15 + | | |
| 1% DPGBE | | |

### Formulation Examples

The following examples illustrate typical liquid formulations for use in healthcare and homecare applications, to provide RSS performance with good shine profiles.

TABLE 6
Residual disinfectant composition examples for healthcare

| | Ex. 6 | Ex. 7 | Ex. 8 |
|---|---|---|---|
| Water | Balance | Balance | Balance |
| Ethanol | 70 | 70 | 0 |
| 2-propanol | 0 | 0 | 70 |
| Polyethyloxazoline | 2 | 2 | 2 |
| Quaternary ammonium | 0.8 | 1.2 | 1.2 |
| compound | | | |
| Wetting agent/surfactant | 0.1 | 0.1 | 0.1 |
| Low Mw polyacrylate | 0.2 | 0.1 | 0.5 |
| Glycol ether | 1 | 1 | 1 |

TABLE 7
Residual disinfectant composition
examples for light duty protectant formulations

| | Ex. 9 | Ex. 10 | Ex. 11 |
|---|---|---|---|
| Polyethyloxazoline | 1.00 | 0.50 | 1.00 |
| Quaternary ammonium compound | 0.40 | 0.20 | 0.20 |
| Fragrance | 0.05 | 0.05 | 0.05 |
| Wetting agent | 0.30 | | |
| Amine oxide | | | 0.30 |
| Ethoxylated alcohol 1 | | | |
| Ethoxylated alcohol 2 | | 0.20 | |
| Alkyl polyglucoside | | | |
| Triethanolamine | | | 0.50 |
| Glycol ether 1 | 1.00 | 0.5 | 1.00 |
| Glycol ether 2 | | | |
| NaEDTA | | 0.10 | |
| Sodium metasilicate | | | |
| Sodium carbonate | | | |
| Citric acid | | | |
| Sulfamic acid | | | |
| Low Mw polyacrylate | 0.20 | 0.20 | 0.20 |
| Water | Balance | Balance | Balance |

TABLE 8
Residual disinfectant composition
examples for all purpose cleaner formulations

| | Ex. 12 | Ex. 13 | Ex. 14 | Ex. 15 |
|---|---|---|---|---|
| Polyethyloxazoline | 1.20 | 1.00 | 1.00 | 1.00 |
| Quaternary ammonium | 0.80 | 0.40 | 0.50 | 0.50 |
| compound | | | | |
| Fragrance | 0.10 | 0.10 | 0.10 | 0.10 |
| Wetting agent | | | | |
| Amine oxide | 0.60 | 0.90 | | |
| Ethoxylated alcohol 1 | | | 0.60 | |
| Ethoxylated alcohol 2 | | | | |
| Alkyl polyglucoside | | | | 0.60 |
| Triethanolamine | | | 0.50 | |
| Glycol ether 1 | 1.00 | 1.00 | | 1.00 |
| Glycol ether 2 | | | 2.40 | |
| NaEDTA | | | | |
| Sodium metasilicate | 0.10 | | | |
| Sodium carbonate | | | | 0.10 |
| Citric acid | | | | |
| Sulfamic acid | | | | |
| Low Mw polyacrylate | 0.50 | 0.20 | 0.20 | 0.20 |
| Water | Balance | Balance | Balance | Balance |

TABLE 9
Residual disinfectant composition
examples for bathroom cleaner formulations

| | Ex. 16 | Ex. 17 | Ex. 18 |
|---|---|---|---|
| Polyethyloxazoline | 1.00 | 1.00 | 1.00 |
| Quaternary ammonium | 0.20 | 0.20 | 0.20 |
| compound | | | |
| Fragrance | 0.10 | 0.10 | 0.10 |
| Wetting agent | | | |
| Amine oxide | | | 0.42 |
| Ethoxylated alcohol 1 | 0.84 | 0.84 | |
| Ethoxylated alcohol 2 | | | 0.50 |
| Alkyl polyglucoside | | | |
| Triethanolamine | | | |
| Glycol ether 1 | | 1.00 | 4.00 |
| Glycol ether 2 | 1.00 | | |
| NaEDTA | 2.90 | | |
| Sodium metasilicate | | | |
| Sodium carbonate | | | |
| Citric acid | | 2.50 | |
| Sulfamic acid | | | 2.50 |
| Low Mw polyacrylate | 0.20 | 0.20 | 0.20 |
| Water | Balance | Balance | Balance |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A disinfectant composition imparting a residual biocidal property, the composition comprising:
i) a polymer binder, wherein the polymer binder is an oxazoline homopolymer or an extended or a modified polymer based on an oxazoline homopolymer having the following molecular structure: 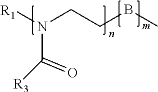
wherein
R1 is selected from hydrogen, alkyl, alkenyl, alkoxy, alkylamino, alkynyl, allyl, amino, anilino, aryl, benzyl, carboxyl, carboxyalkyl, carboxyalkenyl, cyano, glycosyl, halo, hydroxyl, oxazolinium mesylate, oxazolinium tosylate, oxazolinium triflate, silyl oxazolinium, phenolic, polyalkoxy, thiol, or thioether groups.
R3 is selected from hydrogen, alkyl, alkenyl, alkoxy, aryl, benzyl, hydroxyalkyl, or perfluoroalkyl;
B is additional monomer repeating unit linked to oxazoline in a copolymer;
n is in a range of 500 to 250,000 and m is in a range of 20 to 10,000
ii) a biocidal quaternary ammonium compound;
iii) a polyacrylate polymer having a molecular weight from about 100 to about 5,000 g/mol;
iv) a glycol ether of formula R10(R20)nR3 (I)
wherein
R1 is a linear or branched C4, C5 or C6 alkyl, a substituted or unsubstituted phenyl,
R2 is ethyl or isopropyl,
R3 is hydrogen or methyl, preferably hydrogen
n is 1, 2 or 3,; and
v) a carrier.

2. A composition according to claim 1 wherein the polymer binder is prepared with a monomer of ethyloxazoline.

3. A composition according to claim 1 wherein the quaternary ammonium compound has the following formula: 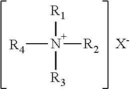
wherein
R1 is alkyl, alkoxy, or aryl, either with or without heteroatoms, or saturated or non-saturated;
R2 is alkyl, alkoxy, or aryl, either with or without heteroatoms, or saturated or non-saturated;
R3 is alkyl, alkoxy, or aryl, either with or without heteroatoms, or saturated or non-saturated;
R4 is alkyl, alkoxy, or aryl, either with or without heteroatoms, or saturated or non-saturated;
X, an anion, is halogen, sulfonate, sulfate, phosphonate, phosphate, carbonate, bicarbonate, hydroxy, or carboxylate.

4. A composition according to claim 1 wherein the quaternary ammonium compound is selected from the group consisting of n-alkyl dimethyl benzyl ammonium chloride, di-n-octyl dimethyl ammonium chloride, dodecyl dimethyl ammonium chloride, n-alkyl dimethyl benzyl ammonium saccharinate, 3-(trimethoxysilyl) propyldimethyloctadecyl ammonium chloride, and a combination thereof.

5. The composition according to claim 1 wherein the quaternary ammonium compound is a mixture comprising: 40% by weight of the mixture of N-alkyl dimethyl benzyl ammonium chloride, 30% by weight of the mixture of N-octyl decyl dimethyl ammonium chloride, 15% by weight of the mixture of di-n-decyl dimethyl ammonium chloride, and 15% by weight of the mixture of di-n-dioctyl dimethyl ammonium chloride.

6. The composition according to claim 1 wherein the quaternary ammonium compound is a polymeric version having a structure of: 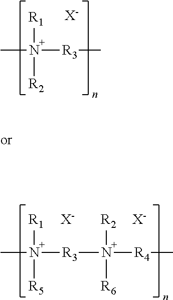
wherein
R1 is hydrogen, methyl, ethyl, propyl or other carbon alkyl group;
R2is hydrogen, methyl, ethyl, propyl or other carbon alkyl group;
R3is methylene, ethylene, propylene or other alkylene linking group;
R4 is methylene, ethylene, propylene or other alkylene linking group;
R5is hydrogen, methyl, ethyl, propyl or other carbon alkyl group;
R6 is hydrogen, methyl, ethyl, propyl or other carbon alkyl group; and
n is in a range of 2 to 10,000.

7. A composition according to claim 1 wherein the polyacrylate polymer is a polyacrylate homopolymer having a molecular weight of from about 500 to about 2,000g/mol.

8. A composition according to claim 1 wherein the polyacrylate polymer is a polyacrylate homopolymer having a molecular weight of from about 800 to about 1,500 g/mol.

9. A composition according to claim 1 wherein the glycol ether is dipropylene glycol n-butyl ether.

10. A composition according to claim 1 wherein the composition is in the form of a liquid.

11. A composition according to claim 1 comprising from about 0.1% to about 10% by weight of the composition of the polymer binder.

12. A composition according to claim 1 comprising from about 0.0005% to about 5% by weight of the composition of the quaternary ammonium compound.

13. A composition according to claim 1 comprising from about 0.0005% to about 5%, by weight of the composition of the polyacrylate polymer.

14. A composition according to claim 1 comprising from about 0.1 to about 1% by weight of the composition of the polyacrylate polymer.

15. A composition according to claim 1 comprising from about 0.1% to about 10%, by weight of the composition of the glycol ether.

16. A composition according to claim 1 comprising from about 0.2 to about 3% by weight of the composition of the glycol ether.

17. A composition according to claim 1 comprising:
i) from about 0.1% to about 4% by weight of the composition of the polymer binder wherein the polymer binder is prepared with a monomer of ethyloxazoline;
ii) from about 0.05% to about 2% by weight of the composition of the quaternary ammonium compound;
iii) from about 0.001% to about 1% by weight of the composition of a polyacrylate polymer having a molecular weight of from about 800 to about 1,500 g/mol;
iv) from about 0.2% to about 3% by weight of the composition of dipropylene glycol n-butyl ether;
v) from about 0.1% to about 10% of a non ionic surfactant; and
vi) from about 1% to 99% of water.

18. An article treated with a composition according to claim 1 wherein the article is in the form of a wipe.

19. An article treated with a composition according to claim 1 wherein the article is in the form of a disposable substrate.
